(19) United States
(12) Patent Application Publication
(10) Pub. No.: US 2009/0164277 A1
(43) Pub. Date: Jun. 25, 2009

(54) SYSTEM AND METHOD FOR MANAGEMENT OF DELIVERY OF GOODS AND SERVICES TO UNATTENDED PREMISES

(76) Inventor: Amor Bhattacharya, Plano, TX (US)

Correspondence Address: Michael A. Rahman, 5664 Mallard Trace, Frisco, TX, 75034, US

(21) Appl. No.: 11/963,840

(22) Filed: Dec. 23, 2007

(51) Int. Cl. G06Q 10/00; G06F 17/00

(52) U.S. Cl. 705/7

(57) ABSTRACT

A system and method provides delivery of services by a service provider to an unattended customer premise. The service provider is connected to the customer via a communication link. The method includes receiving through the service provider's web site a request for a service from the customer. The request for the service includes a description of the requested service. The method further includes receiving customer information including customer identity and the address of the premise where service is requested. The method further includes receiving an access code from the customer, the access code being used to access the customer premise, and providing a service confirmation.

### FIELD OF THE INVENTION

This invention relates generally to systems and methods for delivery of goods and services to any premises. More specifically, this invention relates to a system and method for management of delivery of goods and services utilizing the Internet or other communication links.

### BACKGROUND OF THE INVENTION

Many businesses deliver goods and services to commercial, residential, industrial and other premises. Some businesses deliver boxes, packages, furniture, appliances, and equipments to residential, commercial and industrial premises and other properties. Other businesses deliver services relating to repair, maintenance, replacement and installation of equipments, appliances and other items.

Delivery companies such as UPS, FedEx, United States Postal Service and all local delivery companies often face difficulty delivering packages, boxes and other items to unattended residential or commercial premises because of the inability to gain access to the premises. If there is no one present to open the door to the premise, the delivery companies often attempt to deliver the items to the neighbors or come back the next day, resulting in hundreds of millions of dollars in lost productivity every year. Overnight delivery companies such as UPS and FedEx typically guarantee that packages will be delivered between 8:00 am and 10:00 am. However, if the premise is unattended between 8:00 am and 10:00 am and consequently the delivery driver cannot gain entry to the premise, the delivery driver often will not leave the package at the unattended premise. If the delivery driver cannot deliver a package because a premise is unattended, the driver may leave a note that the delivery was unsuccessful and the recipient must go the delivery company location to pick-up the package. Consequently, the recipient often needs to take time off from work to pick up the package at the delivery company location, causing inconvenience

A customer requiring a service, (e.g., appliance repair service) at a residence or at another premise generally contacts a service provider requesting the service. The service provider (e.g., GE Services, Sears, American Home Shield) schedules the service for a specific day and provides a window (e.g., 4 in the A.M. or P.M. or 8 hours, a full day) in which a service personnel will come to provide the service. The customer typically needs to take time off from work to stay at home (or at the premise) to allow access to the service personnel and explain the service needed. After the service is performed, the customer typically makes a payment for the services rendered by a check or credit card and secures the premise after the service personnel leaves. Thus, the customer generally needs to take time off from work to allow the service personnel to enter the home or another premise. Consequently, employers lose millions of dollars in lost productivity due to employees taking time off from work to allow access to service personnel to their residences. Also, the customers taking time off from work to allow the service personnel access to the premise experience inconvenience and/or loss of pay.

Real estate agents typically gain access to unattended residential or commercial premises via a lock box containing a key to the premises. This lock box which is typically not programmable by the owner of the premises is installed on the doorknob or the door handle or on the wall. The real estate agents can gain access to the premises without any control of the owner of the premise. There are several disadvantages with this type real estate lock box access system. Often, the owner of the premise has no control over the person entering the premise and the system cannot verify the identification of the person entering the premise. Also, if the premise is armed with a security alarm, the owner must turn off the security alarm to allow the real estate agent access.

A few lock box systems allow unattended entry to a premise, but do not prevent unauthorized persons from gaining access using a duplicate key to the lock box. Also, these systems do not allow the premise owner to easily control access to the premise. A few radio frequency controlled lock box systems have been proposed, but they are generally expensive and are suited for high security, remote area or emergency access systems.

Accordingly, there is a need for a system and method that provides a solution to the foregoing problems. There is need for a system and method that allows secure, unattended delivery of goods and services to any premises.

### SUMMARY OF THE INVENTION

A system and method for delivery of goods and services by a service provider to an unattended premise is disclosed. The service provider is connected to a customer via a communication link. The method includes receiving through the service provider's web site or an email a request for a service from the customer. The request for the service includes a description of the requested service. The method further includes receiving customer information including customer identity and the address of the premise where service is requested. The method further includes responding to the customer and providing service availability to the customer, the service availability including one or more dates in which services can be delivered to the customer premise. The method further includes receiving a service date from the customer, the service date being selected from the service availability. The method further includes receiving an access code of the lock box (and a security alarm code if a security system is installed in the premise) from the customer, the access code being used to open the lock box, obtaining the key to access the customer premise, and providing a service confirmation. The method further includes providing the required services at the premise.

In one embodiment, the access code is used to retrieve a key from a lock box. The key is used to unlock a door to enter the premise, thereby allowing the delivery of the services to the premise. Alternatively, the access code may be used to open a door to the premise, thereby allowing the delivery of the services to the premise. For example, the access code may be used to open a programmable door lock installed on the door or to open a garage door from a programmable key pad. The service may be a repair service, or the service may be a delivery of an item such as a box, a package or any other item. The service availability information includes a window time period in which the delivery of the services is made. The method further includes receiving payment information. The payment information may be credit card information. The customer premise may be a residential premise or a commercial premise. The communication link may be the Internet or any other communication link.

### BRIEF DESCRIPTION OF THE DRAWINGS

FIG. 1 is a generalized schematic of a system in accordance with one embodiment of the invention.

FIG. 2 is a flow diagram of a process for delivery of goods and services to an unattended premise according to one example embodiment of the invention.

FIG. 3 is a flow diagram of a process of delivering an item to an unattended premise by receiving an access code from a conveying person.

FIG. 4 is a flow diagram of a process of obtaining an access code from a security company and delivering an item or a service, and FIG. 5 is a flow diagram of a process of allowing service providers to bid for the service.

### DETAILED DESCRIPTION OF THE INVENTION

According to one example embodiment, a system and method allows delivery of goods and services to any unattended premises. The system is implemented using a communication system linked to a wide area network such as the Internet. The system allows a customer to request a service from a service provider, and allows access by a service provider to any unattended location or premise to perform assigned tasks such as repair an appliance, or deliver any item such as a package, a box or furniture. The system may alternatively be implemented using a telephone link, a wireless link or any other suitable and secure communication link.

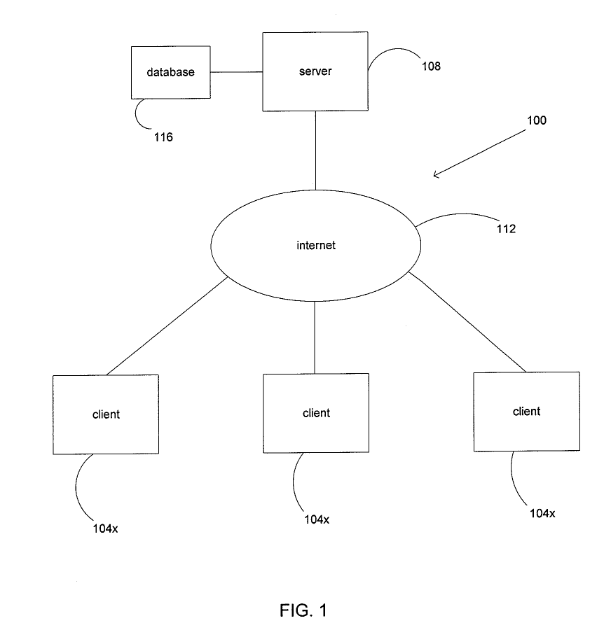

FIG. 1 is a generalized schematic of a system 100 in accordance with one embodiment of the invention. The system 100 includes a plurality of client devices 104x connected to a server 108 through a communication network such as the Internet 112. The client devices 104x each may be a computing device such as a personal computer, a PDA, a mobile computing device, a smart phone or the like. The server 108 is maintained and operated by a service provider that delivers goods or services at a premise (e.g., residential or commercial premise). The server 108 may be connected to a database 116 or the like for storing availability, planning, scheduling, cost and operations information based on a service personnel's availability, workload, schedule, expertise, etc. The information in the database 116 can be updated frequently based on completed tasks, availability, workload, schedule, expertise, etc. In one embodiment, service personnel may update his or her information by sending an email to the server 108 or by logging on to the service provider's web site and provide updated information regarding the service personnel's availability, expertise, schedule, etc. The system 100 compiles information from all service personnel and stores the compiled information in the database 116.

The client devices can exchange messages with the server 108 through the Internet 112 or any other communication link. In one embodiment, the server 108 includes one or more data structures for receiving a service request from a customer and scheduling a service at the customer's premise responsive to information provided by the customer and the information stored in the database 116. Specifically, the server 108 may include one or more data structures for: (1) supporting or informative message exchanges between the client device 104 and the server 108; (2) receiving service requests and related information from customers; (3) presenting service availability information to the customers based on information about the service personnel availability, expertise, workload, etc.; (4) confirming a service schedule; and (5) receiving lock box access code and other related information from the customers. The server 108 also receives payment information from the customer such as a credit card information.

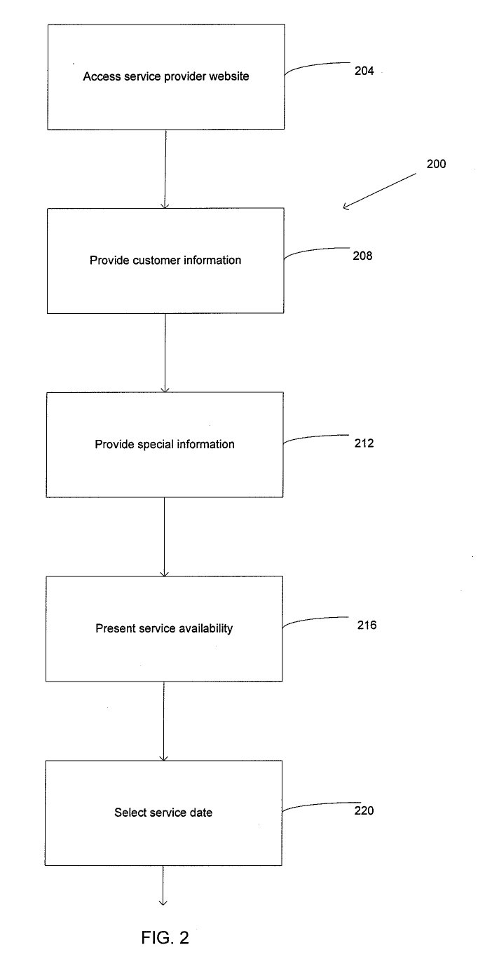

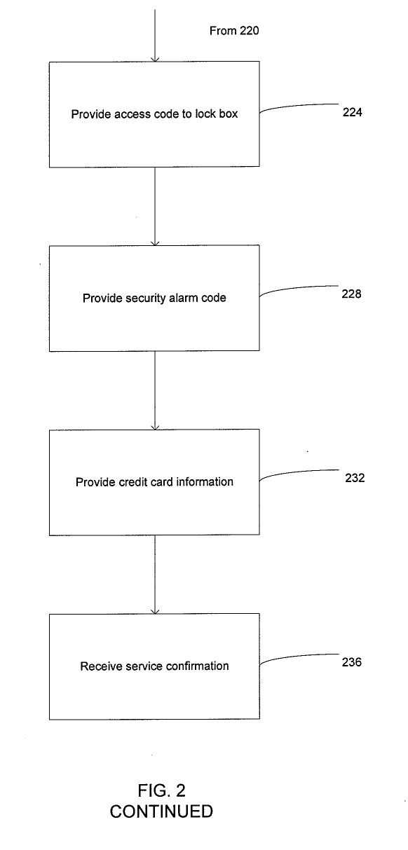

FIG. 2 is a flow diagram of a process 200 for delivery of goods and services to an unattended premise according to one example embodiment of the invention. The process 200 begins at a block 204 in which a customer accesses a service provider's web site. The service provider may, for example, be an appliance manufacturer that provides repair services to the customers. The service provider may, for example, be a business engaged in the delivery of packages or boxes. The customer may use a personal computer or the like to access the service provider's web site via the Internet.

In one example embodiment, the customer requiring a service may be asked to log on to the service provider's web site. The customer may or may not have a preexisting service contract with the service provider. If the customer does not have a preexisting service contract the customer may be allowed to log on to the web site by providing the customer's name and/or other information.

Next, at a block 208, the customer may be required to provide identity, address of the premise, part number of an appliance for which service is desired, and other relevant information. The customer may be required to provide a description of the problem and the type of service desired. The customer may also be asked to provide preferred dates for the service to be performed. The premise may be a residential premise, a commercial premise or an industrial premise.

Next, at block 212, the customer may be requested to provide any special information such as, for example, presence of a guard dog or other pets at the premise so that the service personnel may take necessary precaution. Next, at a block 216, the customer is presented with service availability information. The service availability information may include one or more dates in which the service may be performed and time periods (i.e., a window time period). The service availability information will be compiled based on customer input and the availability of the service personnel. Next, at a block 220, the customer may select one of the dates and time period from the service availability information presented by the service provider. Next, at a block 224, the customer provides an access code for the lock box. The lock box may a commercially available lock box that can be opened using the access code. The lock box may be installed in the knob of the access door to the premise or on a wall. The lock box contains a key to the premise, which is retrieved by opening the lock box using the access code.

Next, at a block 228, the customer may be requested to provide security related information such as a security alarm code to deactivate a security alarm. The security alarm code allows the service personnel to deactivate the security alarm upon entrance to the premise. Next, at block 232, the customer may be required to provide payment information. For example, the customer may be required to provide credit card information. The customer may select other methods of payment such as payment by check upon completion of the service. If the service provider offers a prepaid service contract and the customer has such a preexisting service contract, then the block 232 is not required. Finally, at a block 236, the customer is presented with a confirmation for the service including the date and a window time period for the service to be performed.

On the scheduled date, a repair person shall arrive at the premise. Using the access code, the repair person will open the lock box to retrieve the key to the access door and will enter the premise (e.g., a residential or a commercial building). If a security alarm code was provided by the customer, the repair person may deactivate the security alarm. The repair person will then proceed to perform the requested service. At the completion of the service, the repair person may leave a note explaining the service performed. If the customer opted to pay after the service was performed, the repair person may leave an invoice for the service performed and the customer may pay by a check or by credit card. The repair person can exit the premise, lock the access door using the key and then place the key inside the lock box.

In one embodiment, the lock box is a programmable lock box having an access code that can be changed by the customer at any time. Thus, after the service is performed, the customer may change the access code to the lock box if desired. If the customer requires future service, the customer may then provide the new access code to the service provider using the method described above.

In one embodiment, the service provider may have a planning and scheduling department that maintains and runs the system. The planning and scheduling department may receive the information provided by the customer via the web site. The planning and scheduling department may compare the repair persons availability, workload and expertise with the customer information to identify the suitable repair person to perform the service as well as available days and time windows for the service. It will be understood by those skilled in the art that the planning and scheduling of the service can be implemented in other ways.

The embodiments of the invention can be utilized by shipping or delivery companies (e.g., FedEx, UPS) to efficiently deliver packages, boxes and other items to an unattended premise. A person (a “conveyor”) shipping an item such as a package or a box to a recipient may, for example, obtain an access code to a lock box from the recipient. The conveyor may then provide the access code to the delivery company such as UPS or FedEx along with the item to be shipped, the address of the recipient and payment for the shipment. The access code and other information may be provided to the delivery company online, via a telephone or may be provided in person. Accordingly, the conveyor may hand over the item to be shipped along with the access code to the recipient's lock box, the recipient's address and other information to the delivery company. In one embodiment, preprinted label containing the code for the lock box of the recipient may be attached to the packages to allow the delivery person to enter the premise. Also, a list of code to lock boxes may be provided to the delivery person to enable the delivery person to enter unattended premises.

Alternatively, the access code to the recipient's lock box, the recipient's address and other information may be provided to the delivery company via the Internet, email or telephone. Subsequently, the delivery company can send a driver to pick up the item for shipment. The driver may conveniently enter the recipient's premise using the access code to the lock box without requiring the presence of the recipient at the premise. In one embodiment, the access code may be provided to the delivery driver electronically by email as the driver arrives at the premise. Alternatively, the access code may be provided to the driver via a mobile phone or other mobile device. The delivery company may implement a web site as described above to allow customers to provide the access code to the lock box of the premise where the package, box or other item is to be delivered along with other information. The delivery company may then provide the access code to the delivery driver at an appropriate time to allow the driver access to the premise to deliver the item.

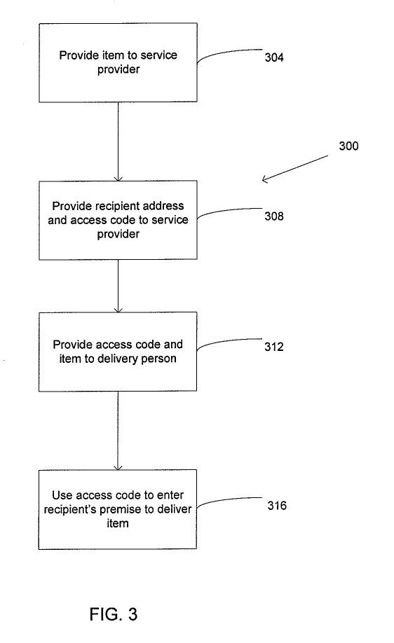

FIG. 3 is a flow diagram 300 of a process of delivering an item (e.g., package, box, etc.) to an unattended premise by receiving the access code from a conveying person (the “conveyor”). The conveyor is the person that intends to ship the item to a recipient. At a block 304, the conveyor provides the item to be shipped to a service provider (e.g., FedEx, UPS, USPS, etc.). At a block 308, the conveyor provides the recipient's address and access code to the service provider. As discussed before, the access code may be used to unlock a lock box to retrieve a key that is used to open a door to the premise. Alternatively, the access code may be used to directly unlock and open a door to the premise. At a block 312, the service provider provides the item and the access code to a delivery person. At a block 316, the delivery person uses the access code to enter the recipient's premise to deliver the item.

In one embodiment, the access code to a premise may be maintained by a third party such as a security company or any other entity (the “security company”). A service provider may request the access code in order to enter the premise to deliver an item or to provide a service. The security company that maintains the access code may contact the owner of the premise for permission to release the access code to the service provider. The service provider may obtain the access code by providing verification and other information. For example, FedEx or UPS may obtain the access code from the security company from providing verification and other information. Alternatively, the owner of the premise may authorize the security company to release the access code to one or more service providers.

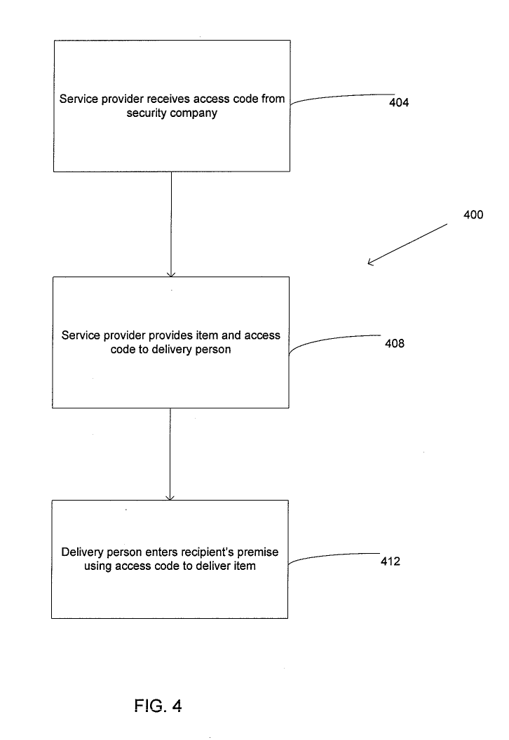

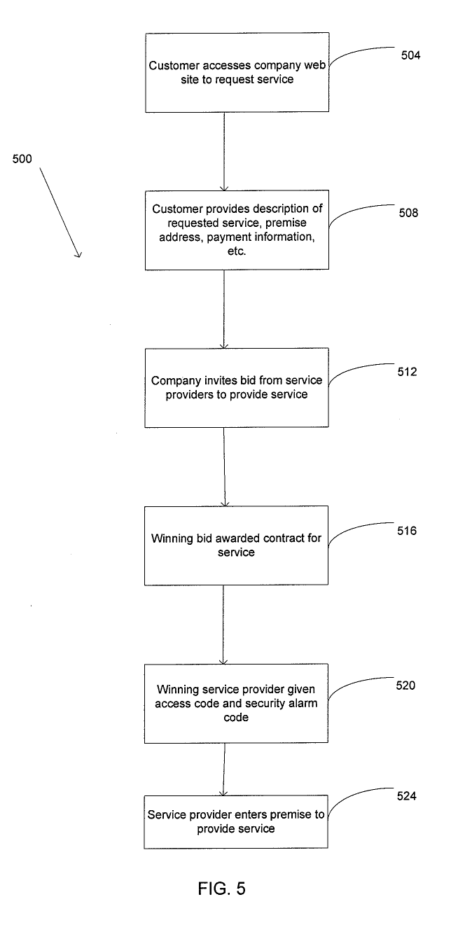

FIG. 4 is a flow diagram 400 of the process of obtaining an access code from the security company and delivering an item or a service. At a block 404, the service provider receives the access code from the security company. At a block 408, the service provider provides an item and the access code to a delivery person. At a block 412, the delivery person enters a recipient's premise using the access code to deliver the item (or provide a service).

In one embodiment, the access code may be used to unlock and open a door to the premise. Thus, the door to the premise may be directly unlocked and opened with the access code without the necessity for a lock box retaining a key. Many commercial and industrial buildings (and some residential buildings) have doors that are unlocked and opened with an access code. Thus, a delivery person may open the door using the access code to deliver an item to an unattended premise. Likewise a repair person may open the door using the access code to provide a service to an unattended premise.

In example implementation, a company may allow customers to access a web site to request one or more services at the customer premise. The premise may be a residential, industrial or commercial premise. The customer may be required to provide a description of the service, address of the premise, contact information and payment information. The customer may be required to provide an access code to a lock box (or programmable door lock or garage door opener) to allow the service provider entry to the premise. If the premise has a security alarm installed, the customer may be required to provide the security alarm code. The company may then allow various service providers to bid for the job, and the winning bid may be awarded with the contract for the job. The bidding service providers may be members of a preferred group or list. The winning service provider will be provider with the access code to the lock box (or programmable door lock or garage door opener) and security alarm code, if applicable, for the service provider to access the premise to provide the service. FIG. 5 is a flow diagram 500 of the foregoing method. In step 504, a customer accesses a company web site to request a service. In step 508, the customer provides a description of the service, address of the premise, payment information, etc. In step 512, the company invites bids from a plurality of service providers to bid for the job or service. In step 516, the winning bid is awarded contract for the job. In step 520, the winning service provider is provided with the access code to the lock box (or programmable door or garage door opener) and security alarm code, if applicable. In step 520, the winning service provider enters the premise using the access code and provides the requested service. In one embodiment, a computer program product comprising a computer usable medium having computer-readable instructions embodied on the computer-readable medium implements a method for initiating a delivery of goods or services to a premise using the steps described above.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the implementations of the present invention is as a routine in an operating system made up of programming steps or instructions resident in a memory of a computing system as well known, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a general purpose digital computer, software applications, routines and software modules, hardware including application specific integrated circuits, programmable logic devices, field programmable gate arrays, optical and other mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed is:

1. A method for delivery of services by a service provider to an unattended customer premise, the service provider being connected to the customer via a communication link, comprising:
receiving through the service provider's web site a request for a service from the customer, the request for the service including a description of the requested service;
receiving customer information including customer identity and the address of the premise where service is requested;
providing service availability to the customer, the service availability including one or more dates in which services can be delivered to the customer premise;
receiving a service date from the customer, the service date being selected from the service availability;
receiving an access code from the customer, the access code being used to access the customer premise;
providing a service confirmation.

2. The method of claim 1, wherein the access code is used to retrieve a key from a lock box, and wherein the key is used to unlock a door to enter the premise, thereby allowing the delivery of services to the premises.

3. The method of claim 1, wherein the access code is used to open a door to the premise, thereby allowing the delivery of the services to the premise.

4. The method of claim 1, wherein the service is a repair service.

5. The method of claim 1, wherein the service is a delivery of goods.

7. The method of claim 1, wherein the service availability information includes a window time period in which the delivery of the services is made.

8. The method of claim 1, further comprising receiving payment information, wherein payment information includes credit card information.

9. The method of claim 1, further comprising receiving payment information, wherein the payment information includes a method of payment for the service.

10. The method of claim 1, wherein the customer premise is a residence.

11. The method of claim 1, wherein the customer premise is a commercial premise.

12. The method of claim 1, wherein the communication link is the Internet.

13. A method for delivery of services by a service provider to an unattended customer premise, the service provider being connected to the customer via a communication link, comprising:
receiving through the service provider's web site a request for a service from the customer, the request for the service including a description of the requested service;
receiving customer information including customer identity and the address of the premise where service is requested;
receiving an access code from the customer;
providing a service confirmation;
using the access code to enter the premise;
delivering the service to the premise.

14. The method of claim 13, wherein the service is a repair service.

15. The method of claim 13, wherein the service is a delivery of an item.

16. The method of claim 13, wherein the communication link is the Internet.

17. The method of claim 13, further comprising receiving payment information.

18. A method for delivery of services by a service provider to an unattended customer premise, the service provider being connected to the customer via a communication link, comprising:
receiving through the service provider's web site a request for a service from the customer, the request for the service including a description of the requested service;
receiving customer information;
receiving an access code from the customer, the access code being used to access the customer premise;
providing a service confirmation.
delivering the service to the customer premise.

19. The method of claim 18 further comprising receiving customer identity and the address of the premise where service is requested.

20. The method of claim 18 further comprising:
providing service availability to the customer, the service availability including one or more dates in which the service can be delivered to the customer premise;
receiving a service date from the customer, the service date being selected from the service availability.

21. The method of claim 18, wherein the service is a repair service.

22. The method of claim 18, wherein the service is a delivery of an item.

22. The method of claim 18, wherein the communication link is the Internet.

23. The method of claim 13, further comprising receiving payment information from the customer.

24. A method for a delivery service provider to deliver an item to an unattended premise, comprising:
receiving, from a conveyor, an item to be delivered to the premise;
receiving, through the service provider's web site, the address of the premise and an access code, the access code being used to access the premise;
entering the premise using the access code to deliver the item.

25. The method of claim 24 wherein the access code is received through the Internet.

26. A method for a delivery service provider to deliver an item to an unattended premise, comprising:
receiving, from a conveyor, an item to be delivered to the premise;
receiving the address of the premise;
receiving from a security company an access code, the access code being used to access the recipient's premise;
entering the premise using the access code to deliver the item.

27. The method of claim 26, wherein the access code is provided to the security company by the recipient of the item.

28. The method of claim 26, wherein the security code is received by the delivery service provider through the Internet.

29. A system for delivery of services by a service provider to an unattended customer premise, the service provider being connected to the customer via a communication link, comprising:
a server connected to the customer via the communication link;
a database linked to the server, the database configured to store customer information and service availability information;
the server configured to generate a plurality of web pages for receiving a request for a service from the customer, the request for the service including a description of the requested service, receiving customer information and an access code from the customer, the access code being used to access the customer premise, and providing a service confirmation.

30. The system of claim 29, wherein the access code is used to retrieve a key from a lock box, and wherein the key is used to unlock a door to enter the customer premise, thereby allowing the delivery of the services to the customer premises.

31. The system of claim 29, wherein the access code is used to open a door to the customer premise, thereby allowing the delivery of the services to the premise.

32. The system of claim 29, wherein the service is a repair service.

33. The system of claim 29, wherein the service is a delivery of goods.

34. The system of claim 29, wherein the web pages are configured to receive payment information, wherein payment information includes credit card information.
